(19) United States
(12) Patent Application Publication
(10) Pub. No.: US 2021/0219556 A1
(43) Pub. Date: Jul. 22, 2021

(54) VARIABLE INSERT BAKING TRAY AND PAN DEVICE

(71) Applicant: Emily Guglielmo, Orlando, FL (US)

(72) Inventor: Emily Guglielmo, Orlando, FL (US)

(21) Appl. No.: 16/745,112

(22) Filed: Jan. 16, 2020

(51) Int. Cl. A21B 3/13; A47J 36/16

(52) U.S. Cl. CPC A21B 3/131; A21B 3/132; A47J 36/16

(57) ABSTRACT

Variable insert baking tray and pan device is disclosed herein. In one embodiment the device may comprise a cooking device, such as a baking pan, having a plurality of baking trays removably installed therein. The device may comprise a notch and shelf design, wherein the interior of the cooking pan provides a shelf onto which one of the baking trays may be placed for baking. The notch design may be implemented to allow all of the plurality of baking trays to be placed within the baking pan for storage. The plurality of baking trays may be sized such that a first fits into a second, which fits into a third, and so on, for stacking and storage within the baking pan. The handles of the baking pan may further comprise heat resistant material for user safety.

### TECHNICAL FIELD OF THE INVENTION

The present invention relates in general to cooking devices, and, more specifically, to variable insert baking tray and pan device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Cooking is the practice of preparing food for consumption, and the techniques used in cooking vary widely based on cultural and personal preferences. Cooking may be done almost anywhere, such as in the home, in a restaurant kitchen, or even outdoors, so long as a heat source is available. Such a heat source may be any appropriate source such as an electric or gas stove, microwave, oven, or open fire. The materials being cooked, whether meats, fruits and vegetables, water, or any other items, are often kept separate from the heat source through the use of various cooking devices.

A pan, frying pan, or skillet, for example, is a cooking device that is generally flat-bottomed and having relatively low sides that flare outwards. Pans are generally equipped with a relatively long handle for control, and are often used without a lid, though a sauté pan may incorporate a lid for lower-heat cooking methods. The length of the handle allows for more active control of the pan, and some versions may incorporate a second grip opposite the handle for additional control.

A baking pan, as another example, is a cooking device that is generally flat bottomed and having straight, relatively low sides and a square or rectangular shape. Baking pans are generally equipped with short, wide handles used for placing such a device into and removing it from an oven.

A pot or stock pot, as another example, is a cooking device that is generally flat-bottomed and having straight, relatively high sides. Pots often have two grip handles that may be used to lift or tilt the device, and are better suited to preparing liquid-based dishes such as soups, stocks, or broths. Because pots tend to be larger and contain more volume than pans they are not actively handled during the cooking process and, thus, do not require a longer control handle.

A baking tray, as another example, is a cooking device that is generally flat and comprises recesses into which a baking mix may be poured for baking. The shape of the recesses may define the final shape of the baked good, or an insert may be placed into the recess to define the shape of the baked good. Baking trays generally do not comprise a separate handle, as they can be manipulated by holding the edges of the flat surface.

Various other types of cooking devices are in common usage, varying in their diameters, the flare and height of their sides, and their types and number of handles based on the style of cooking to be implemented. Such various devices include, for example, griddles, brasing pans, woks, sauce pans, pie pans, and casserole pots. Rarely, though, is a cooking device designed for one purpose suitable to the purposes of a different design. It is possible, though, to combine the design elements of a baking pan and a baking tray to create the present device.

Thus, there is a need in the art for variable insert baking tray and pan device that combines the design elements of a baking pan and a baking tray to provide a user with additional functionality. It is to these ends that the present invention has been developed.

### BRIEF SUMMARY OF THE INVENTION

To minimize the limitations in the prior art, and to minimize other limitations that will be apparent upon reading and understanding the present specification, the present invention describes variable insert baking tray and pan device.

It is an objective of the present invention to provide variable insert baking tray and pan device that may comprise a cooking device.

It is another objective of the present invention to provide variable insert baking tray and pan device that may comprise a baking pan.

It is another objective of the present invention to provide variable insert baking tray and pan device that may comprise a baking tray.

It is another objective of the present invention to provide variable insert baking tray and pan device that may comprise a plurality of baking trays.

It is another objective of the present invention to provide variable insert baking tray and pan device that may comprise a large recess baking tray.

It is another objective of the present invention to provide variable insert baking tray and pan device that may comprise a medium recess baking tray.

It is another objective of the present invention to provide variable insert baking tray and pan device that may comprise a small recess baking tray.

It is another objective of the present invention to provide variable insert baking tray and pan device that may comprise a baking tray storage device.

It is another objective of the present invention to provide variable insert baking tray and pan device that may comprise a plurality of handles.

It is another objective of the present invention to provide variable insert baking tray and pan device that may comprise a plurality of grips.

It is another objective of the present invention to provide variable insert baking tray and pan device that may comprise a notch and shelf design.

It is another objective of the present invention to provide variable insert baking tray and pan device that may comprise a heat resistant layer.

It is another objective of the present invention to provide variable insert baking tray and pan device that may comprise a resilient material of construction.

It is another objective of the present invention to provide variable insert baking tray and pan device that may comprise an antimicrobial layer.

It is another objective of the present invention to provide variable insert baking tray and pan device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an upper isometric perspective view of variable insert baking tray and pan device, as contemplated by the present disclosure;

FIG. 2 illustrates a top plan view of variable insert baking tray and pan device, as contemplated by the present disclosure;

FIG. 3 illustrates a left side elevation view of variable insert baking tray and pan device, as contemplated by the present disclosure;

FIG. 4 illustrates a front side elevation view of variable insert baking tray and pan device, as contemplated by the present disclosure;

FIG. 5 illustrates an upper isometric perspective view of variable insert baking tray and pan device with baking tray inserts removed, as contemplated by the present disclosure;

FIG. 6 illustrates an upper isometric perspective view of variable insert baking tray and pan device and baking tray inserts, as contemplated by the present disclosure; and

FIG. 7 illustrates an upper isometric perspective view of variable insert baking tray and pan device and baking tray insert, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

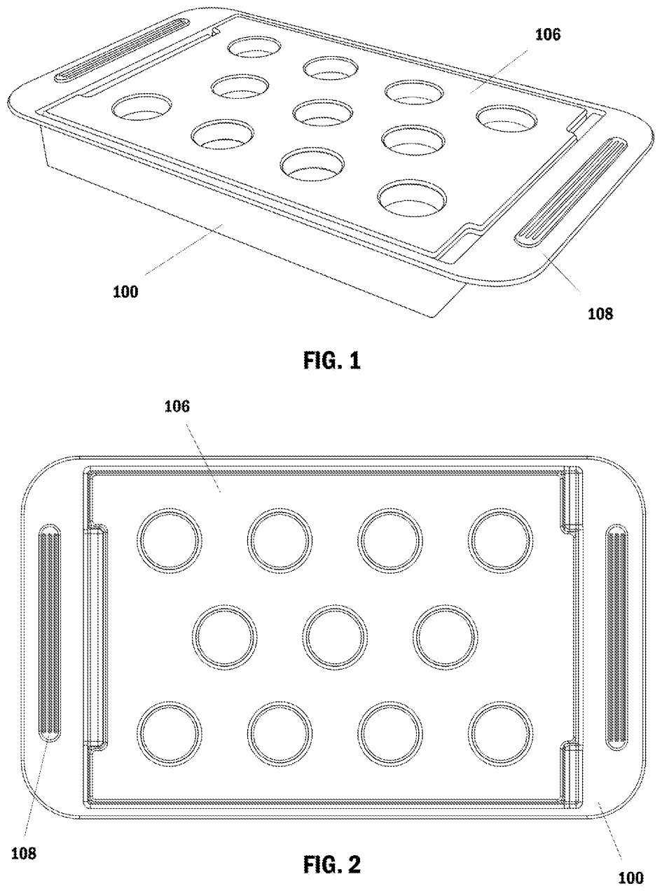

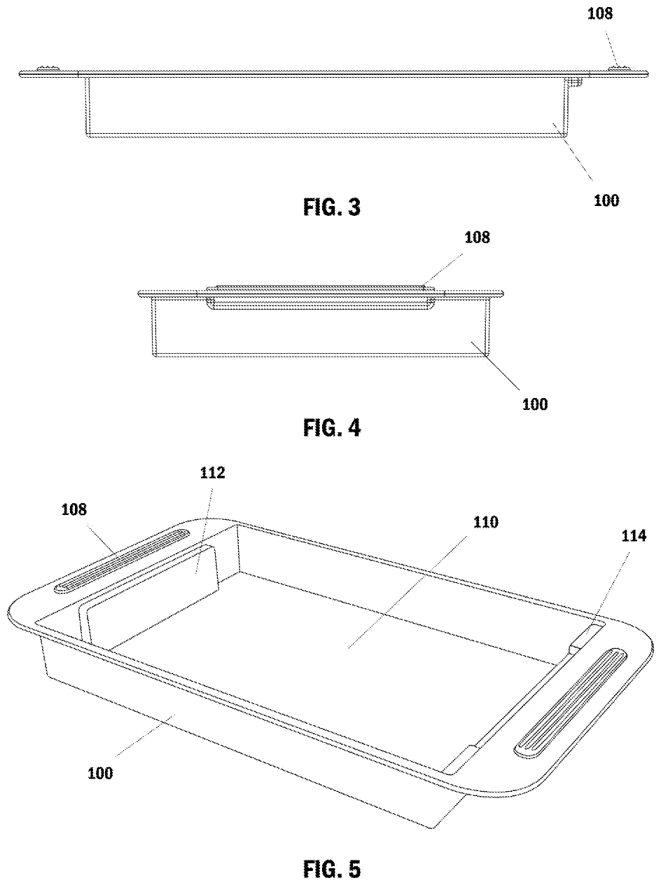

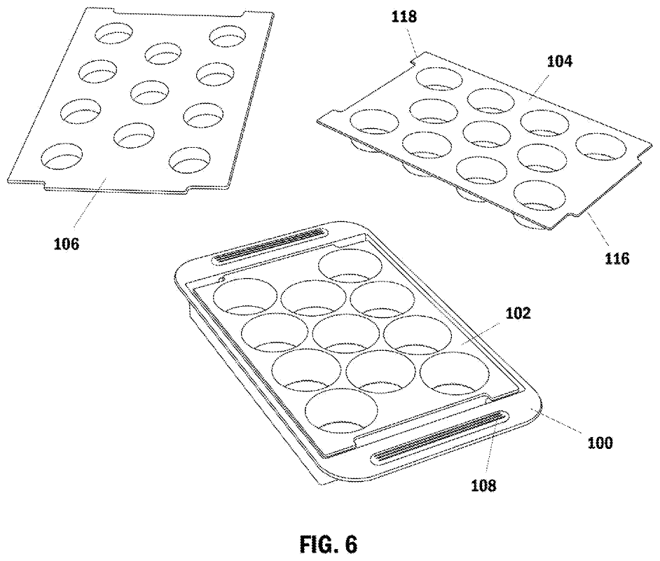

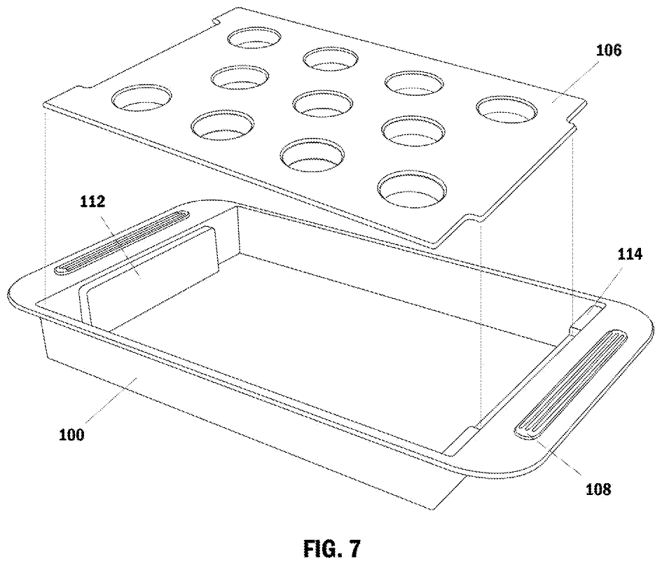

The illustrations of FIGS. 1-7 illustrate variable insert baking tray and pan device, as contemplated by the present disclosure. In one embodiment the device may comprise a cooking device, such as a baking pan, having a plurality of baking trays removably installed therein. The device may comprise a notch and shelf design, wherein the interior of the baking pan provides a shelf onto which one of the baking trays may be placed for baking. The notch design may be implemented to allow all of the plurality of baking trays to be placed within the baking pan for storage. The plurality of baking trays may be sized such that a first fits into a second, which fits into a third for stacking and storage within the baking pan. The handles of the baking pan may further comprise heat resistant material for user safety.

The device may comprise, generally, a baking pan 100 and a plurality of baking tray inserts. In one embodiment the baking pan 100 may comprise a generally square or rectangular horizontal surface having a first side, a second side, a first end, a second end, and a central cavity 110. The first side, second side, first end, and second end may form a lip around the perimeter of the central cavity 110. The central cavity 110 may further comprise a middle notch shelf 112, which may be attached to a first end of the central cavity 110, and a lateral notch shelf 114, which may be attached to a second end of the central cavity 110.

The baking pan 100 may comprise any size appropriate to a baking pan, and may vary in its length, width, and height of its sides as desired. By way of example, the dimensions of the baking pan 100 of the variable insert baking tray and pan device may be approximately twenty-one (21) inches in length, twelve (12) inches in width, and two and one half (2.5) inches in height.

In one embodiment the plurality of baking tray inserts may comprise three baking tray inserts, which may be a large recess baking tray 102, a medium recess baking tray 104, and a small recess baking tray 106. The plurality of baking tray inserts may further comprise a generally square or rectangular horizontal surface having a first side, a second side, a first end, a second end, and a plurality of recesses. The perimeter dimensions of the plurality of baking tray inserts may match the perimeter dimensions of the baking tray 100 central cavity 110 of a particular embodiment.

The first end of each of the plurality of baking tray inserts may further comprise a middle notch 116, which may comprise a width identical to the width of the middle notch shelf 112 of a particular embodiment. The second end of each of the plurality of baking tray inserts may further comprise a lateral notch 118, which may comprise a width identical to the width of the lateral notch shelf 114 of a particular embodiment.

The large recess baking tray 102 may comprise a plurality of large-sized recesses arranged throughout its horizontal surface. By way of example, the plurality of recesses may be arranged in multiple rows organized so as to maximize the number of recesses present throughout the horizontal surface. The medium recess baking tray 104 may comprise a plurality of medium-sized recesses arranged throughout its horizontal surface such that a central point of each of the medium-sized recesses matches the central point of each of the large-sized recesses. The small recess baking tray 106 may comprise a plurality of small-sized recesses arranged throughout its horizontal surface such that a central point of each of the small-sized recesses matches the central point of each of the medium-sized recesses.

By the design the small recess baking tray 106 may be placed on the medium recess baking tray 104 such that the small-sized recesses fit within the medium-sized recesses and the small recess baking tray 106 horizontal surface rests on the medium recess baking tray 104 horizontal surface. The medium recess baking tray 104 may then be placed on the large recess baking tray 102 such that the medium-sized recesses fit within the large-sized recesses and the medium recess baking tray 104 horizontal surface rests on the large recess baking tray 102 horizontal surface. In this way the plurality of baking tray inserts may be stackable and may fit within the central cavity 110 of the variable insert baking tray and pan device.

The baking pan 100 may further comprise a plurality of grips 108, wherein one of the plurality of grips is attached to the first end of the baking pan 100, and one of the plurality of grips is attached to the second end of the baking pan 100. The plurality of grips 108 may comprise a heat-resistant material of construction for user safety.

To begin using the device a user may take the baking pan 100 and one of the plurality of baking tray inserts, and may orient the selected baking tray insert such that its middle notch 116 is positioned above the middle notch shelf 112 and its lateral notch 118 is positioned above the lateral notch shelf 114. The user may then lower the selected baking tray insert into the central cavity 110, and the selected baking tray will be supported such that its horizontal surface is generally planar to the horizontal surface of the baking pan 100. The user may then cook baked goods sized according to the selected baking tray insert. Alternatively, the user may remove the baking tray insert and may then cook baked goods sized according to the central cavity 110.

To begin storing the device a user may take the baking pan 100 and the plurality of baking tray inserts, and may orient the plurality of baking tray inserts such that their middle notches 116 are positioned above the lateral notch shelf 114 and their lateral notches 118 are positioned above the middle notch shelf 112. The user may then first lower the large recess baking tray 102 into the central cavity 110, then lower the medium recess baking tray 104 into the central cavity 110, and finally lower the small recess baking tray 106 into the central cavity 110. The shape of the various shelves and notches are such that the plurality of baking tray inserts are permitted to rest on the surface below them and, as such, all of the plurality of baking tray inserts may be positioned within the central cavity 110.

The variable insert baking tray and pan device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the variable insert baking tray and pan device may be substantially constructed of one or more materials of plastic, acrylic, ceramic, polycarbonate, steel, aluminum, brass, fiberglass, carbon fiber, or combinations thereof. In some embodiments the various components of the system may be coated, lined, or otherwise insulated to prevent contamination. In one embodiment the material of construction may vary from one component to the next within the system.

In one embodiment the variable insert baking tray and pan device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A variable insert baking tray and pan device, comprising:
a baking pan; and
a plurality of baking tray inserts;
wherein said baking pan further comprises a central cavity and a plurality of grips;
wherein said central cavity further comprises a middle notch shelf and a lateral notch shelf; and
wherein said plurality of baking tray inserts further comprise a plurality of recesses, a middle notch, and a lateral notch.

2. The invention of claim 1,
wherein said middle notch shelf is attached to a first end of said central cavity;
wherein said lateral notch shelf is attached to a second end of said central cavity;
wherein said middle notch comprises a first end of each of said plurality of baking tray inserts; and
wherein said lateral notch comprises a second end of each of said plurality of baking tray inserts.

3. The invention of claim 2,
wherein said plurality of baking tray inserts comprise a large recess baking tray, a medium recess baking tray, and a small recess baking tray.

4. The invention of claim 3,
wherein each of said plurality of baking tray inserts further comprise a plurality of recesses.

5. The invention of claim 4,
wherein said plurality of recesses of said large recess baking tray comprise large-sized recesses;
wherein said plurality of recesses of said medium recess baking tray comprise medium-sized recesses; and
wherein said plurality of recesses of said small recess baking tray comprise small-sized recesses.

6. The invention of claim 5,
wherein said small-sized recesses fit into said medium-sized recesses; and
wherein said medium-sized recesses fit into said large-sized recesses.

7. The invention of claim 6,
wherein said plurality of baking tray inserts are stackable.

8. The invention of claim 7,
wherein said plurality of baking tray inserts are stackable within said central cavity.

9. The invention of claim 8,
wherein one of said plurality of baking tray inserts is placeable within said central cavity such that said middle notch is placed on said middle notch shelf and said lateral notch is placed on said lateral notch shelf.

10. The invention of claim 9, further comprising:
a plurality of grips;
wherein said plurality of grips are attached to said baking pan.

11. The invention of claim 10,
wherein said plurality of grips comprise a heat-resistant material of construction.
